(19) United States
(12) Patent Application Publication
(10) Pub. No.: US 2023/0153283 A1
(43) Pub. Date: May 18, 2023

(54) DATA STANDARDIZATION SYSTEM AND METHODS OF OPERATING THE SAME

(71) Applicant: Rakuten Symphony Singapore Pte. Ltd., Singapore (SG)

(72) Inventors: Dewa Siswanto, Tokyo (JP); Murugavel Natarajan, Karnataka (IN)

(21) Appl. No.: 17/455,404

(22) Filed: Nov. 17, 2021

(51) Int. Cl. G06F 16/22

(52) U.S. Cl. CPC G06F 16/22

(57) ABSTRACT

Embodiments of a method of standardizing data are disclosed. In some embodiments, first data structures are obtained at a computer device in multiple database formats. A standardized database format is defined at the computer device. In some embodiments, the first data structures are converted into second data structures, wherein each of the second data structures are each in the standardized database format.

### BACKGROUND

Generally, raw data obtained from a data sources (such as a network monitoring element, sales recording system, data forecasting system, etc.) includes a huge amount of information that is not meaningful for and readable by an end user. Thus, raw data needs to be processed in order to identify and extract useful data, and the extracted useful data can then be compiled to a dataset which is readable to the end user. However, this process is often very burdensome since raw data often comes in different and incompatible data formats.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a data standardization system, in accordance with some embodiments.

FIG. 2 is a visual representation of a table creation script for a user data structure with a database format in the comma-separated value (CSV) database language, according to some embodiments.

FIG. 3 is a visual representation of a table creation script for a user data structure with a database format in the java script object notation (JSON) database language, according to some embodiments.

FIG. 4 is a visual representation of a table for a user data structure in a standardized database format, according to some embodiments.

FIG. 5A is a graphical user interface (GUI) 500 for generating the data structures from standardized data structures, in accordance with some embodiments.

FIG. 5B is the GUI shown in FIG. 5A illustrating additional data suggestions, in accordance with some embodiments.

FIG. 5C is the GUI shown in FIG. 5A illustrating additional data suggestions, in accordance with some embodiments.

FIG. 6 is a GUI section, which is a portion of the GUI discussed with respect to FIG. 5A, in some embodiments.

FIG. 7 is another example of a GUI section, which is a portion of the GUI discussed with respect to FIG. 5A, in some embodiments.

FIG. 8 is a pop-out window for selecting how to join different data suggestions, in accordance with some embodiments.

FIG. 9 is a block diagram of data standardization software, in accordance with some embodiments.

FIG. 10 is a flowchart regarding a method of standardizing data, in accordance with some embodiments.

FIG. 11 is a flowchart regarding a method of converting the first data structures into second data structures in standardized database formats, in accordance with some embodiments.

FIG. 12 is a flowchart regarding a method of generating the one or more data suggestions regarding combining data from the second data structures.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Systems and methods of standardizing data are disclosed. Data structures often are generated in multiple data sources, wherein the data structures are configured in multiple database formats. These database formats are often incompatible. For example, different data structures from different data sources sometimes represent the same type of object or action (e.g., users, customers, stores, sales transactions, employee information, work profiles, etc.) in the real world or in the virtual world. In some embodiments, the data structures from different data sources are written in different database languages. In other embodiments, the data structures from different data sources are in the same language but have incompatible configurations. The systems and method disclosed herein standardize the data structures in these multiple database formats into standardized database formats. By standardizing the database format of the data structures from the various data sources, new and more useful data structures are created from the standardized data structures in some embodiments.

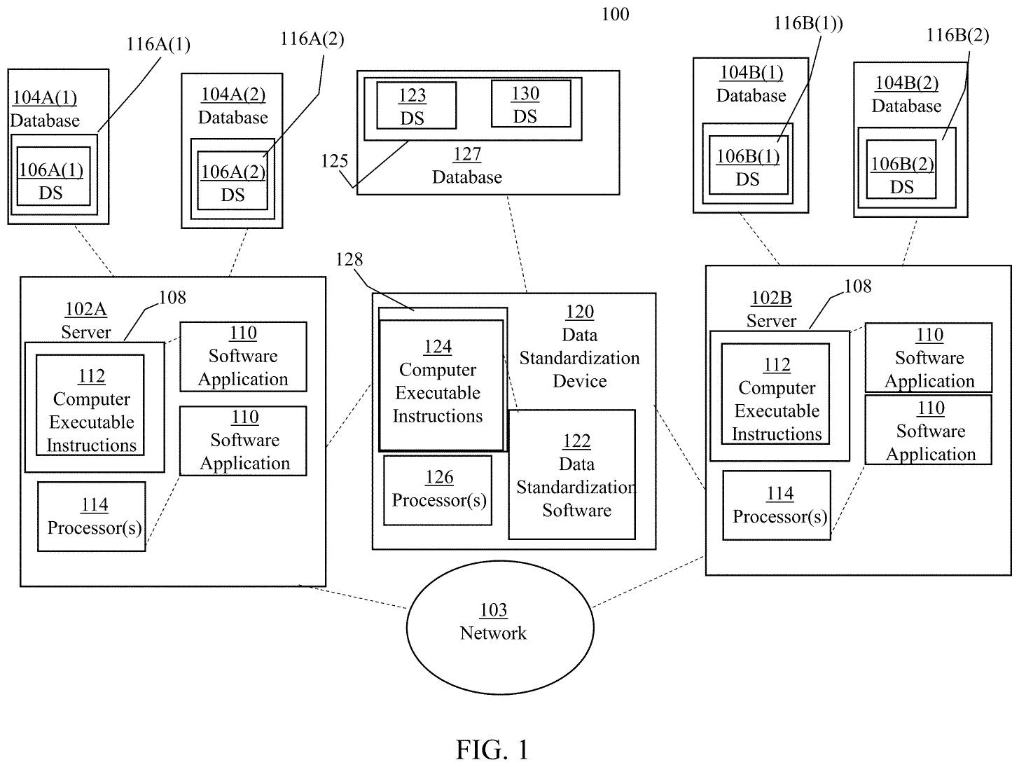

FIG. 1 is a block diagram of a data standardization system 100, in accordance with some embodiments.

Data standardization system 100 includes servers 102A, 102B (referred to generically or collectively as server(s) 102) that are operably connected to databases 104A(1), 104A(2), 104B(1), 104B(2) (referred to generically or collectively as databases 104). Servers 102 are connected to a network 103 and are configured to manage the writing and storing of data structures 106A(1), 106A(2), 106B(1), 106B(2) (referred to generically or collectively as data structures 106) stored in non-transitory computer readable media 116A(1), 116A(2), 116B(1), 116B(2) (referred to collectively or generically as non-transitory computer readable media 116). In some embodiments, the network 103 includes a wide area network (WAN) (i.e., the internet), a wireless WAN (WWAN) (i.e., a cellular network), a local area network (LAN), and/or the like.

More specifically, the server 102A is communicatively connected (e.g., through a device interface) to database 104A(1) and database 104A(2). In some embodiment, database 104A(1) and database 104A(2) are included in server 102A. In some embodiment, database 104A(1), database 104A(2), and server 102A, are included in a cloud server. The database 104A(1) includes non-transitory computer readable media 116A(1) that stores data structures 106A(1). In some embodiments, the data structures 106A(1) have a particular database format, such as Java Script Object Notation (JSON). The database 104A(2) includes non-transitory computer readable media 116A(2) that stores data structures 106A(2). In some embodiments, the data structures 106A(2) have a particular database format, such as American Standard Code for Information Interchange (ASCII).

The server 102B is communicatively connected (e.g., through a device interface) to database 104B(1) and database 104B(2). In some embodiment, database 104B(1) and database 104B(2) are included in server 102B. In some embodiment, database 104B(1), database 104B(2), and server 102B, are included in a cloud server. The database 104B(1) includes non-transitory computer readable media 116B(1) that stores data structures 106B(1). In some embodiments, the data structures 106B(1) have a particular database format, such as extensible markup language (XML). The database 104B(2) includes non-transitory computer readable media 116B(2) that stores data structures 106B(2). In some embodiments, the data structures 106B(2) have a particular database format, such as comma separated values (CSV).

It should be noted that JSON, ASCII, XML, and CSV are simply exemplary and are not in any way limiting. In some embodiments, the data structures 106 are in other suitable database formats. Furthermore, in this particular example, the data structures 106 of each database 102 are in a particular one of the database formats JSON, ASCII, XML, and CSV. In other embodiments, database structures 106 in the same database 104 are in different database formats. For example, in some embodiments, some of the data structures 106A(1) are in JSON and some of the data structures 106A(1) are in XML.

To manage the writing and storing of data structures 106 in the databases 104 and to perform other functionality, the servers 102 implement different software applications 110. Software applications 110 are provided as computer executable instructions 112 that are executable by one or more processors 114 in each of the servers 102. The computer executable instructions 112 are stored on non-transitory computer readable medium 108 within each of the servers 102. In some embodiments, non-transitory computer-readable media 108, 116 include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In FIG. 1, the data standardization system 100 includes more than one of the servers 102 and more than one of the databases 104. Also, in FIG. 1, each of the servers 102 is configured to manage more than one of the databases 104. In other embodiments, the data standardization system 100 includes a single server 102 and a single database 104. In still other embodiments, the data standardization system 100 includes multiple servers 102 that manage a single database 104. In still other embodiments, multiple servers 102 are configured to manage the same subset of databases 104. These and other configurations for the data standardization system 100 are within the scope of this disclosure.

The data standardization system 100 thus includes a data standardization device 120. The data standardization device 120 is a computer device that implements the data standardization software 122 as computer executable instructions 124 executed on one or more processors 126. The computer executable instructions 124 are stored on a non-transitory computer readable medium 128. In some embodiments, non-transitory computer-readable media 128 include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer device.

Data standardization software 122 is configured to standardize the data structures 106 in databases 104 into a standardized database format by the servers 102. More specifically, data standardization device 120 is configured to obtain the data structures 106 from the databases 104, define a standardized database format, and convert the data structures 106 into data structures 123, wherein the data structures 123 are each in the standardized database format. The data structures 123 are stored on a non-transitory computer readable media 125 in a database 127 communicatively coupled to the data standardization device 120. In some embodiments, the data structures 123 are configured as database tables that each include the data from the data structures 106.

For example, in some embodiments, a subset of the data structures 106A(1) are user data objects in JSON that includes data for users. A subset of the data structures 106A(2) are user data objects in ASCII that includes data for users. A subset of the data structures 106B(1) are user data objects in XML that includes data for users. A subset of the data structures 106B(2) are user data objects in CSV that includes data for users. In some embodiments, the data standardization software 122 is configured to generate a subset of the data structures 123 as user data structures in the standardized user database format from the subsets of data structures 106A(1), 106A(2), 106B(1), 106B(2). In some embodiments, the subset of data structures 123 are each in a user database table.

In another example, data standardization software 122 is configured to define a standardized store database format. In some embodiments, the standardized store database format is a store database table with a specified set of database fields related to a store. In other embodiments, the standardized store database format is in one of either JSON, ASCII, XML, or CSV but however is in a format where data is extracted from the data structures 106 to generate the data structures 123 in a standardized store database format.

For example, in some embodiments, a subset of the data structures 106A(1) are store data objects in JSON that includes data for stores. A subset of the data structures 106A(2) are store data objects in ASCII that includes data for stores. A subset of the data structures 106B(1) are store data objects in XML that includes data for stores. A subset of the data structures 106B(2) are store data objects in CSV that includes data for stores. In some embodiments, the data standardization software 122 is configured to generate a subset of the data structures 123 as store data structures in the standardized store database format from the subsets of data structures 106A(1), 106A(2), 106B(1), 106B(2). In some embodiments, the subset of data structures 123 are each in a store database table.

The data structures 123 standardize how the data is stored and provide the different subsets of the data with the same level of structure in order to be able to build more complex and useful data structures from the data structures 123. In some embodiments, the data standardization software 122 generates one or more dataset suggestions regarding combining data from the second data structures. In some embodiment, the dataset suggestions correspond to suggested data formats, where the suggested data formats are combinations of the standardized data formats. For example, the standardized store data format is combined with standardized user data formats. In this manner, a standardized data format is created to store and user data is combined to provide purchase histories, user item selection at particular stores, and other useful information regarding user behavior in association with specific stores.

In some embodiments, the data standardization software 122 presents a dataset preview of the one or more dataset suggestions though a graphical user interface being implemented by the computer device. In some embodiments, the data suggestions are manipulated by a user through a graphical user interface. For example, a user selects to add or remove certain fields from the data suggestions. In some embodiments, user input is received through the graphical user interface regarding a dataset selection. The dataset selection includes a selection regarding combinations of standardized database formats, portions of standardized database formats, or added fields selected for use in a combination of the standardized database formats.

In some embodiments, the data standardizing software 122 generates data structures 130 from the data structures 123 in accordance with the dataset selection. For example, the subset of data structures 123 with standardized store database formats and the subset of data structures 123 with standardized user database formats are combined into a subset of data structures 130. In some embodiments, this subset of data structures 130 link store data with user data. Data structures 130 are stored on the non-transitory computer readable media 125 in database 127.

In some embodiments, a user has the option to continuously stream the data structures 106 from the databases 104 and generates data structures 123 in accordance with standardized data formats. The data standardization software 122 scans through the data structures 123 (e.g., tables) to analyze and provide data previews. In some embodiments, the data previews include visual representations of statistical data and include data suggestions for a user regarding the best way to combine different data structures 123.

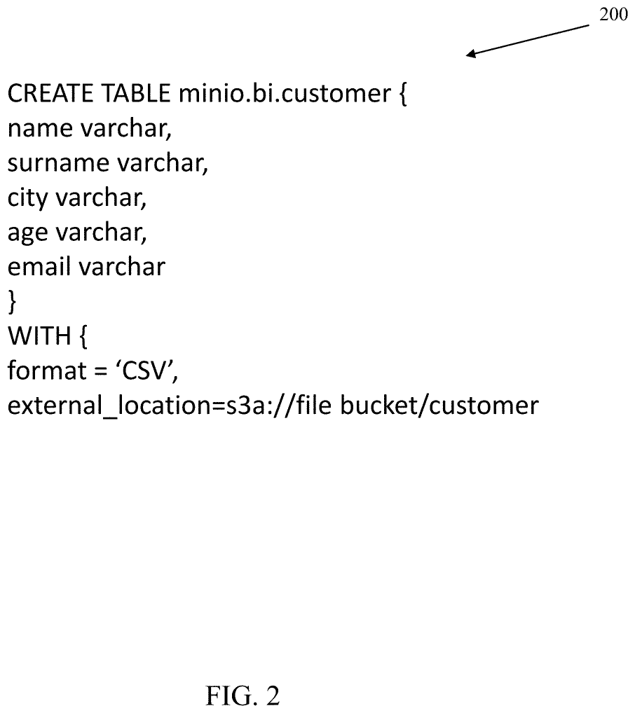

FIG. 2 is a visual representation of a table creation script 200 for a customer data structure (i.e., a type of user data structure) with a database format in the CSV database language, according to some embodiments.

The table creation script generates the customer data structure in a table format that corresponds to data structures 123 in FIG. 1 with a customer data structure that corresponds to data structures 106B(2) in FIG. 1. As shown, the script calls “CREATE TABLE” for an object storage program (in this case, minio) to obtain the customer data structure in the CSV and generate a table from the CSV field/types, “name varchar,” “surname varchar,” “city varchar,” “age varchar,” and “email varchar.” The table creation script 200 identifies the database language (e.g., CSV) of the database format and that the table should be placed in the file location “local file bucket/customer.” In FIG. 2, the script is a script for a database query program, which in this example is trino.

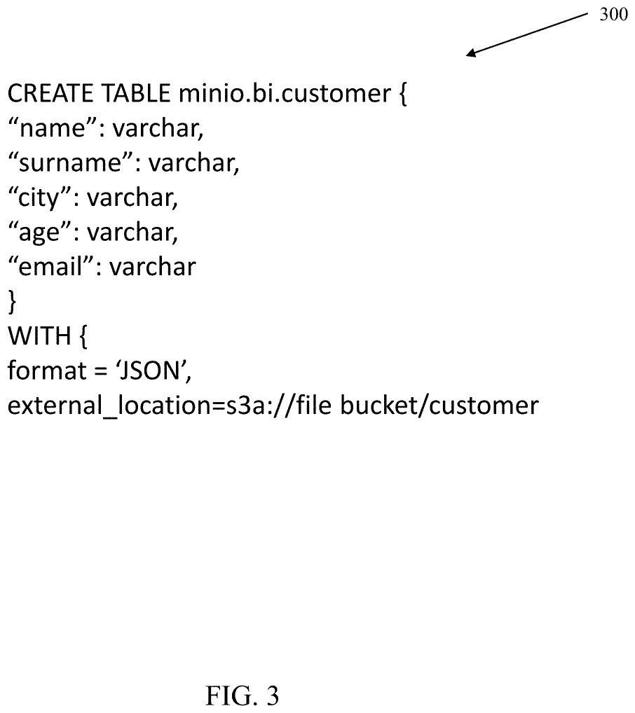

FIG. 3 is a visual representation of a table creation script 300 for a customer data structure with a database format in the JSON database language, according to some embodiments.

The table creation script generates the customer data structure in a table format that corresponds to data structures 123 in FIG. 1 with a customer data structure that corresponds to data structures 106A(1) in FIG. 1. As shown, the script calls “CREATE TABLE” for an object storage program (in this case, minio) to obtain the customer data structure in the JSON and generate a table from the JSON field/types, ““name:” varchar”, ““surname”: varchar”, ““city”: varchar,” ““age”: varchar,” and ““email”: varchar”. The table creation script 300 identifies the database language (e.g., JSON) of the database format and that the table should be placed in the file location “local file bucket/customer.” In FIG. 3, the script is a script for a database query program, which in this example is trino.

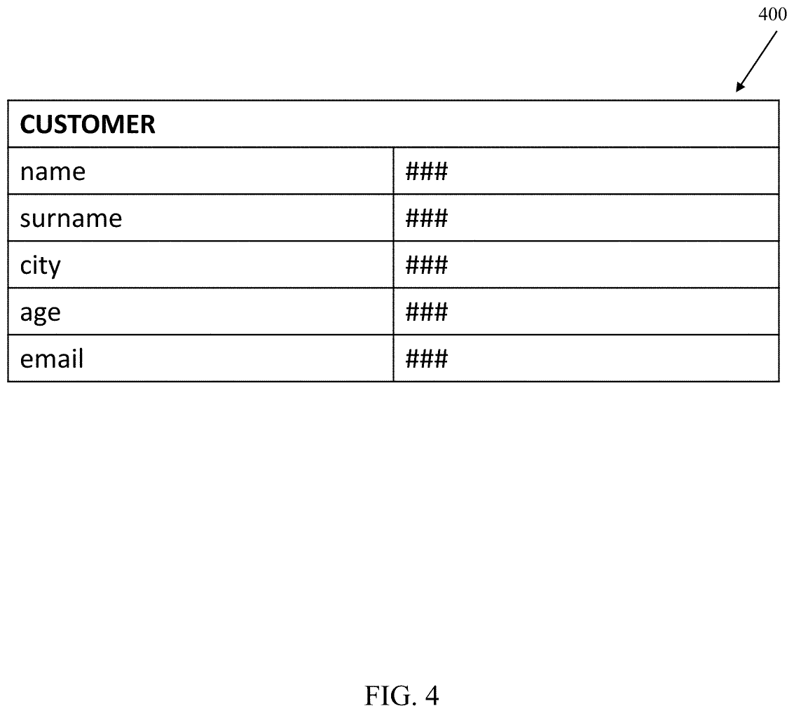

FIG. 4 is a visual representation of a table 400 for a customer data structure in a standardized database format, according to some embodiments.

The table 400 is one example of data structures 130 in FIG. 1. As shown, table is for a data structure “CUSTOMER.” The table 400 is created from script 200 in FIG. 2 and/or from script 300 in FIG. 3. In some embodiments, scripts are written for customer data structures in ASCII and customer data structures in XML, which may corresponds to data structures 106A(2), 106B(1), respectively. As shown, the table 400 includes fields “name:” with an associated parameter, a field “surname” with an associated parameter, a field “city” with an associated parameter, a field “age” with an associated parameter and a field “email” with an associated parameter. Said associated parameters can include, for example, value, character, or combination thereof. With these types of scripts, the data standardization software 122 (See FIG. 1) is configured to generate the data structures 123 in a standardized database format, such as the table 400, in some embodiments. In this manner, although the content of data structures 123 were extracted from data structures 106A(1), 106A(2), 106B(1), 106B(2) in different database formats (some of which are in different database languages), the data structures 123 are standardized.

Once the data structures 123 are in standardized database formats, the data in the data structures 123 are combined into data structures 130 (See FIG. 1), in some embodiments. The data standardization software 122 is thus configured to standardize the data structures 106 to generate the standardized data structures 123. The data standardization software 122 is then configured to identify (e.g., with rule-based modules or AI modules) which data in the data structures 123 is useful and construct the data structures 130 as a useful and readable dataset.

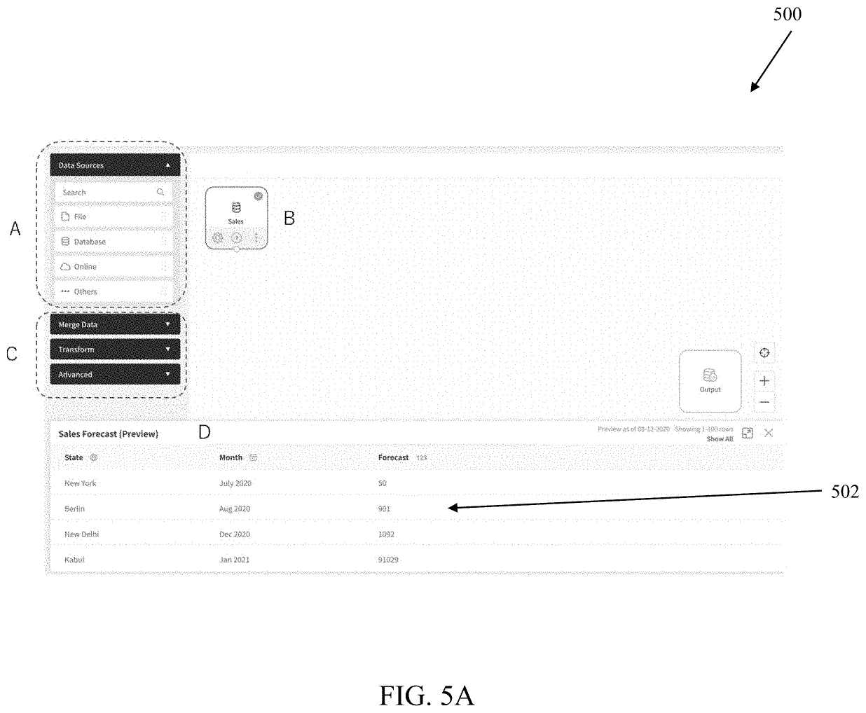

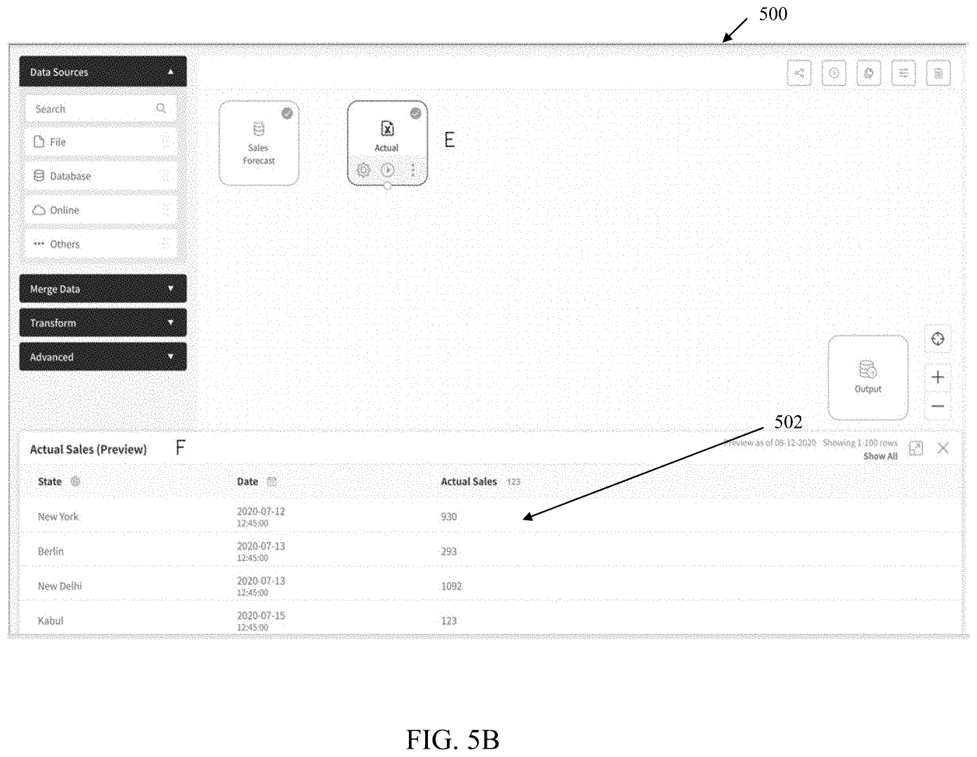

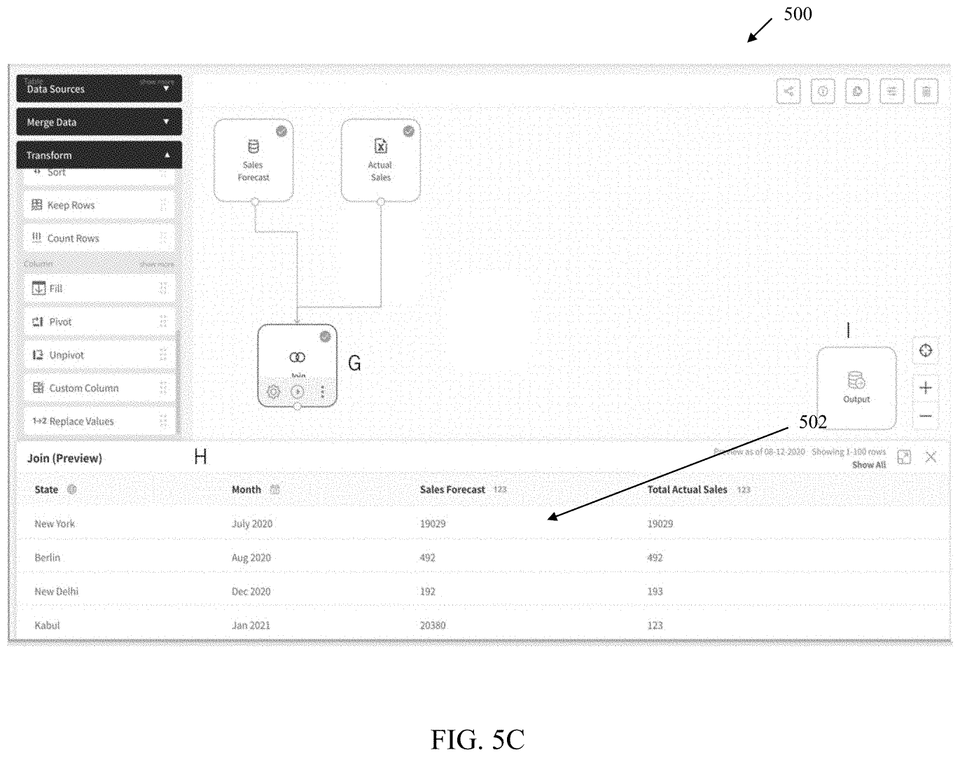

FIG. 5A is a graphical user interface (GUI) 500 for generating the data structures 130 from standardized data structures 123, in accordance with some embodiments.

The GUI 500 visually presents a data preview 502 (See Section D) of data suggestions to the user. The data suggestions are suggested data structures and/or data formats that have been extracted from the standardized data structures 123 (See FIG. 1). The data preview allows the user to configure/manipulate the dataset suggestions visually presented in the data preview 502.

In Section A of the GUI 500, the GUI 500 includes a search bar and various selections for data sources including file sources, databases, online sources, and other miscellaneous sources. The GUI 500 is configured so that the user manipulates the GUI 500 and selects the sources from which the standardized data structures, such as the standardized structures 123, originated. In some embodiments, clicking data source options results in a pop-out window (which contain multiple options of available data source and/or datasets in some embodiments). In some embodiments, the data source options allow from drag and drop from particular computer devices (e.g., user equipment, local computer, etc.) to the GUI 500. In some embodiments, command codes are inserted using options from the data sources. These and other options are available with the data source options. In the search bar, a user inputs a keyword into the search box resulting in data source and/or dataset suggestions related to the keyword. The suggestions are generated with a rule base module in some embodiments and with an AI module in some embodiments.

Section B includes a block element that describes a data suggestion, e.g., data structures for “Sales Forecast” generated as a result of the manipulation of section A.

Section C of the GUI 500 includes various option for manipulating and configuring the data structures of the data suggestions. One of the options in section C is a merge option that allows for a user to select to merge certain subsets of data structures 123. Another option is a transform option that allows for a user to transform the data structures 123. Section C can also include miscellaneous options, such as advanced options like calculated field creation, embedded Statistic and/or an AI Machine Learning model.

Section D is associated with the data preview 502 of data suggestions. In this case, data suggestions are suggested data structures that are creatable from a subset of the data structures 123. In this case, the suggested data structures related to Sales Forecast in different cities, as described in Section D.

In some embodiments, the GUI 500 is configured to receive a user input that simply accepts the data suggestions as provided and generates a subset of the data structures 130 without a change in the data suggestions. In other embodiments, the GUI 500 is configured to receive a user input with data manipulations that adjust the data suggestions in order to generate the subset of the data structures 130 in accordance with the modified data suggestions, as explained in further detail below.

FIG. 5B is the GUI 500 shown in FIG. 5A illustrating additional data suggestions, in accordance with some embodiments.

In FIG. 5B, section B in FIG. 5A is now shown as section E in FIG. 5B, merely for the purpose of clarifying that this section is now including additional element and is different from the one in FIG. 5A. In section E, additional data structures are shown as data suggestions. In this case, a selection is shown in section E named “Actual,” which is a selection for actual sales data structures.

Section D in FIG. 5A is now shown as section F in FIG. 5B. Section F is a data preview of the data suggestions of the data preview 502 related to the actual sales data structures. As shown, the suggested actual sales data structures include the “State” data field described above. Furthermore, the suggested actual sales data structures include a “Date” data field that describes the data and time of sales made and a field named “Actual Sales” that describe an amount of the actual sales.

FIG. 5C is the GUI 500 shown in FIG. 5A illustrating additional data suggestions, in accordance with some embodiments.

In FIG. 5C, section E in FIG. 5A is now shown as section G in FIG. 5C. In section E, additional data structures are shown as data suggestions. In the following example, a user provides user input through a drag-and-drop functionality of the GUI 500 to implement a “Join” function from “Merge Data” in section C to join the suggested sales forecast data structures with the suggested actual sales data structures. Block elements in Section G include the Join block element. Accordingly, the data standardization software 122 is configured to join the suggested sales forecast data structures with the suggested actual sales data structures.

Section F in FIG. 5B is now shown as section H in FIG. 5C. Section F is a data preview is a visual representation of the data suggestions related to the actual sales data structures. As shown, the suggested join data structures include the “State” data field described above. Furthermore, the suggested join data structures include the “Date” data field that describes the data and time of sales made. Additionally, the suggested join data structures include the “Sales Forecast” data field that describe an amount of the forecast sales and the field named “Actual Sales” that describe an amount of the actual sales.

In some embodiments, the GUI 500 is configured to receive user input to manipulate the data suggestions (e.g., joining data from specific rows or columns, simply combining the two data suggestions, etc.). In some embodiments, the user can insert a computer-readable command (e.g., “join column X and column Y”, “shift data Z to left column”, etc.) into the GUI 500. In some embodiments, the GUI 500 is configured to provide drop-down list that are manipulated by the user via user input in order to select a data configuration. Through these data selections, the GUI 500 is configured to allow the user to generate desired data structures 130 from standardized data structures 123.

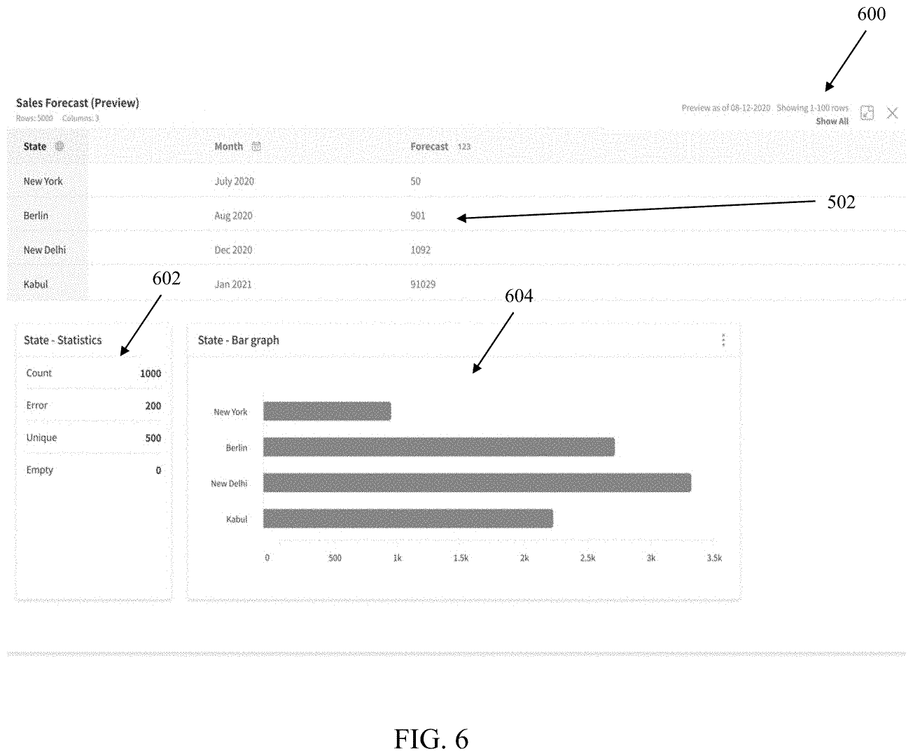

FIG. 6 is a GUI section 600, which is a portion of the GUI 500 discussed with respect to FIG. 5A, in some embodiments.

In some embodiment, the GUI section 600 is presented as a new preview window scrolling down a scroll bar in Section D of GUI 500. In some embodiments, the GUI 500 is configured to trigger the presentation of GUI section 600 by simply clicking a dedicated button (e.g., “Show All”, “Show More”, etc.), by inserting a command code, by pressing keyboard shortcut keys (e.g., Ctrl+X), and the like.

In this embodiment, the GUI section 600 includes the data preview 502 of the data suggestions. Said data suggestions include a visual representation of a table that includes a field for a “State” (which actually corresponds to a city), a field(s) for a “month,” and field(s) for a sales “Forecast” for the particular month. Subsection 602 of the GUI section 600 includes a visual representation of classification statistics regarding the data suggestions. Subsection 602 is a visual representation of table. The table includes a “Count” field that describes a number of data structures of the data suggestions, an “Error” field that identifies how many data structures resulted in a <null> value, a “Unique” data field that describes how many records have a unique value, and an “Empty” data field that describes how many records returned no value. Subsection 604 is a bar graph that visually represents statistical data regarding the data suggestions. The bar graph represents a unique value summary for individual fields with string or text data type.

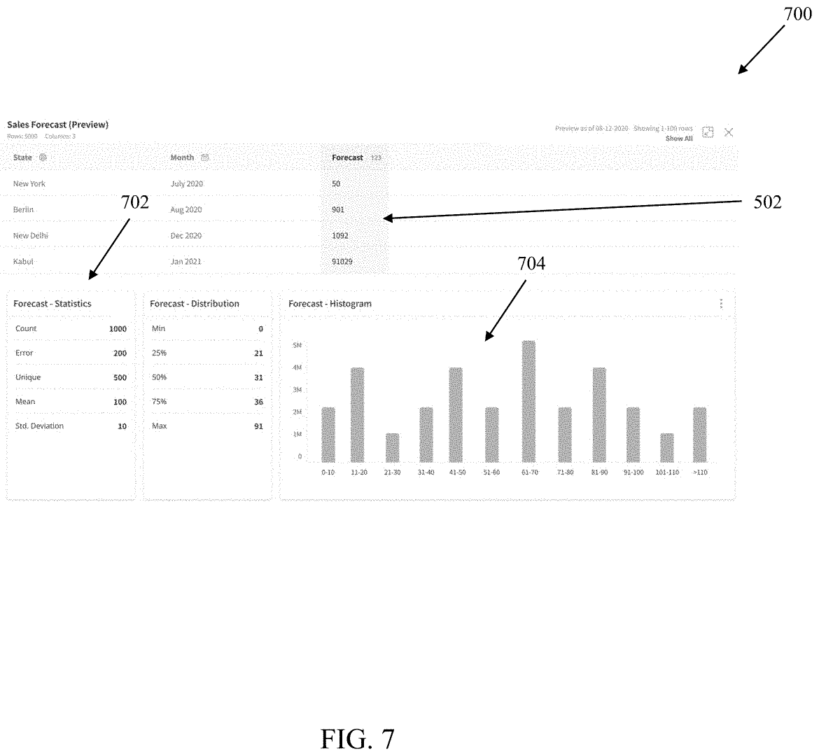

FIG. 7 is another example of a GUI section 700, which is a portion of the GUI 500 discussed with respect to FIG. 5A, in some embodiments.

In some embodiment, the GUI section 700 is presented as a new preview window scrolling down a scroll bar in Section D of GUI 500. In some embodiments, the GUI 500 is configured to trigger the presentation of GUI section 700 in a new preview window by simply clicking a dedicated button (e.g., “Show All”, “Show More”, etc.), by inserting a command code, by pressing keyboard shortcut keys (e.g., Ctrl+X), and the like.

In this embodiment, the GUI section 700 includes the visual representation of the data suggestions, as described with respect to FIG. 6. Subsection 702 of the GUI section 700 includes a visual representation of classification statistics regarding the data suggestions. Subsection 702 is a visual representation of table. The table includes a “Count” field that describes a number of data structures of the data suggestions, an “Error” field that identifies how many data structures resulted in a <null> value, a “Unique” data field that describes how many records have a unique value, an “Mean” data field that describes an average value among the data suggestions, and a “Std. Deviation” which describes a standard deviation of the data suggestions. Subsection 702 also includes a visual representation of a table named “Forecast—Distribution.” The table describes a distribution of the sales forecast.

Subsection 704 is a bar graph that visually represents statistical data regarding the data suggestions. The bar graph is a histogram describing selected fields with a number data type.

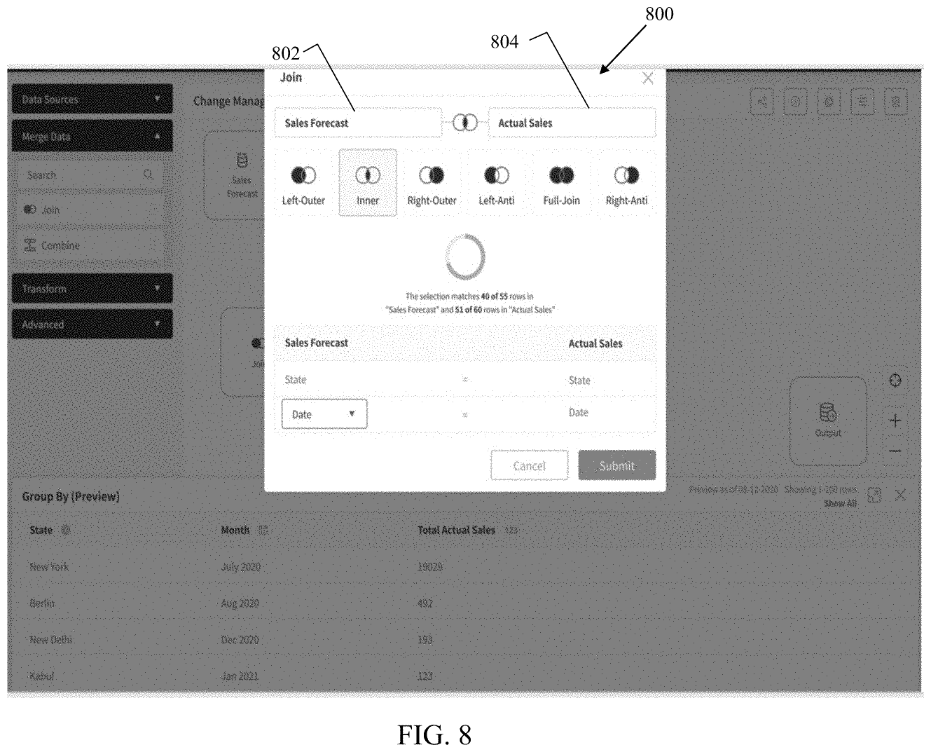

FIG. 8 is a pop-out window 800 for selecting how to join different data suggestions, in accordance with some embodiments.

In some embodiments, the pop-out window is generated by the GUI 500 in FIGS. 5A-5C once the join functionality is selected as shown in FIG. 5C. The pop-out window 800 includes description boxes 802, 804 identifying the data suggestions that are to be joined. In this example, the data suggestions for “Sales Forecast” and the data suggestions for “Actual Sales” are to be joined.

A yen diagram option named Left Outer describes a function where all of the fields of the data suggestions described in description box 802 and a portion of the fields of the data suggestions described in description box 804 which also described in description box 802 are maintained. A yen diagram option named Inner describes a function where only the fields that the data suggestions described in description box 802 and the data suggestions described in description box 804 are maintained. A yen diagram option named Right Outer describes a function where all of the fields of the data suggestions described in description box 804 and a portion of the fields of the data suggestions described in description box 802 which also described in description box 804 are maintained. A yen diagram option named Left Anti describes a function where the fields of the data suggestions described in description box 802 are maintained except for the data fields that the data suggestions described in description box 802 have in common with the data suggestions described in description box 804. A yen diagram option named Full Join describes a function where all of the fields of the data suggestions described in description box 802 and all of the fields that the data suggestions described in description box 804 are maintained. A yen diagram option named Right Anti describes a function where the fields of the data suggestions described in description box 804 are maintained except for the data fields that the data suggestions described in description box 804 have in common with the data suggestions described in description box 802. Once the user provides user input regarding a yen diagram selection, the data standardization software 122 is configured to provide the functionality described by the yen diagram selection and generate the appropriate subset of data structures 130 for the data suggestions described in description boxes, 802, 804. In some embodiments, once the user provides user input regarding the yen diagram selection, the data standardization software 122 is configured to present a success rate indication includes a progress circle as illustrated in pop-out window 800, a numerical value (e.g., in percentage, in ratio, etc.), a progress bar, and some other suitable options of representation.

In some embodiments, once the user entered the user input that with the appropriate data selection, the data standardization software 122 automatically updates the dataset preview based on the data selection. In some embodiments, the data selection for the data structures is then presented by the GUI 500 with an updated dataset preview in real time. Once the user is satisfied with the updated data selection, the user provides user input (e.g., by pressing on a confirm button, by inserting a command, etc.) that triggers the data standardization software 122 to generate the appropriate subset of the data structures 130. In some embodiments, the user can simply click on the “Output” block element or simply press shortcut keys on keyboard (e.g., Ctrl+X) to trigger the generation of the appropriate subset of the data structures 130. In some embodiments, the data structures 130 are configured as excel tables, as tables in ASCII, as tables in JSON, and/or the like.

In some embodiments, the GUI 500 is configured to allow a user to select a save option (e.g., by pressing a dedicated “Save” button, by pressing Ctrl+S, etc.) that saves the subset of data structures 130 and the associated configurations. By doing so, when the user wants to obtain an updated data structures 130 in accordance with the same configuration in the future, the user simply provides user input to open a saved configuration file, and the data standardization software 122 automatically obtains the latest data structures 123 and automatically generates a data preview based on the data structures 123. Subsequently, the user can review the latest data suggestions from the preview and instruct the data standardization software 122 to generate a latest data structures 130 thereafter. In some embodiments, the user can simply select (e.g., drag-and-drop, etc.) a saved configuration file into a update dataset portion (not explicitly shown) of the GUI 500 and the data standardization software 500 generates an updated data structures 130 based on the saved configuration, without requiring the user to review the data suggestions.

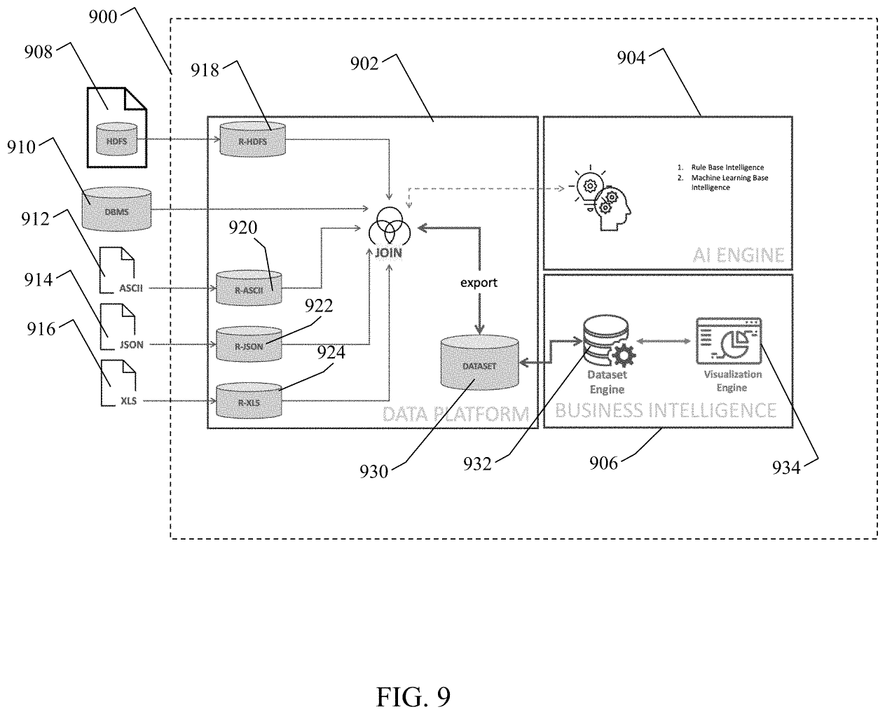

FIG. 9 is a block diagram of data standardization software 900, in accordance with some embodiments.

The data standardization software 900 corresponds with the data standardization software 122 in FIG. 1. The data standardization software 900 includes a data platform module 902, an AI engine 904, and a business intelligence (BI) module 906. The data platform module 902 is configured to receive data structures 908, 910, 912, 914, 916 from one or more data sources. The data sources include different network systems, different vendor computer devices, different user computer devices, databases in one or more network locations, the cloud, and/or other software applications (e.g., through an application programming interface (API)).

Data structures 908 have a database format in accordance with the computer language Hadoop Distributed File System (HDFS). Data structures 910 have a database format in accordance with the computer language Database Management System (DBMS). Data structures 912 have a database format in accordance with the computer language ASCII. Data structures 914 have a database format in accordance with the computer language JSON. Data structures 916 have a database format in accordance with the computer language excel (XLS).

The data platform module 902 is configured to receive the data structures 908, 910, 912, 914, 916 and generate data structures 918, 920, 922, 924 in standardized data formats. In this example, the standardized data formats are all in DBMS. Data structures 910 are not reformatted because these data structures are already in DBMS. The data platform module 902 is configured to generate the data structures 918 (labeled R-HDFS) in the standardized database formats written in DBMS from the data structures 908 in HDFS. The data platform module 902 is configured to generate the data structures 920 (labeled R-ASCII) in the standardized database formats written in DBMS from the data structures 912 in ASCII. The data platform module 902 is configured to generate the data structures 922 (labeled R-JSON) in the standardized database formats written in DBMS from the data structures 914 in JSON. The data platform module 902 is configured to generate the data structures 924 (labeled R-XLS) in the standardized database formats written in DBMS from the data structures 916 in XLS.

The AI engine 904 uses both rule-base intelligence and artificial intelligence to determine data suggestions from the data structures 910, 918, 920, 922, 924. The data suggestions are a dataset 930 of suggested data structures that have joined data from the data structures 910, 918, 920, 922, 924. The BI module 906 obtain the dataset 930 and a dataset engine 932 in the BI module 906 is configured to determine relevant data, such as statistical data related to the dataset 930. A visualization engine 934 in the BI module 906 is configured to present a GUI (e.g., GUI 500) to a user so that user input is received and the data engine 932 manipulates the data structures 910, 918, 920, 922, 924 in accordance to data selections from the GUI.

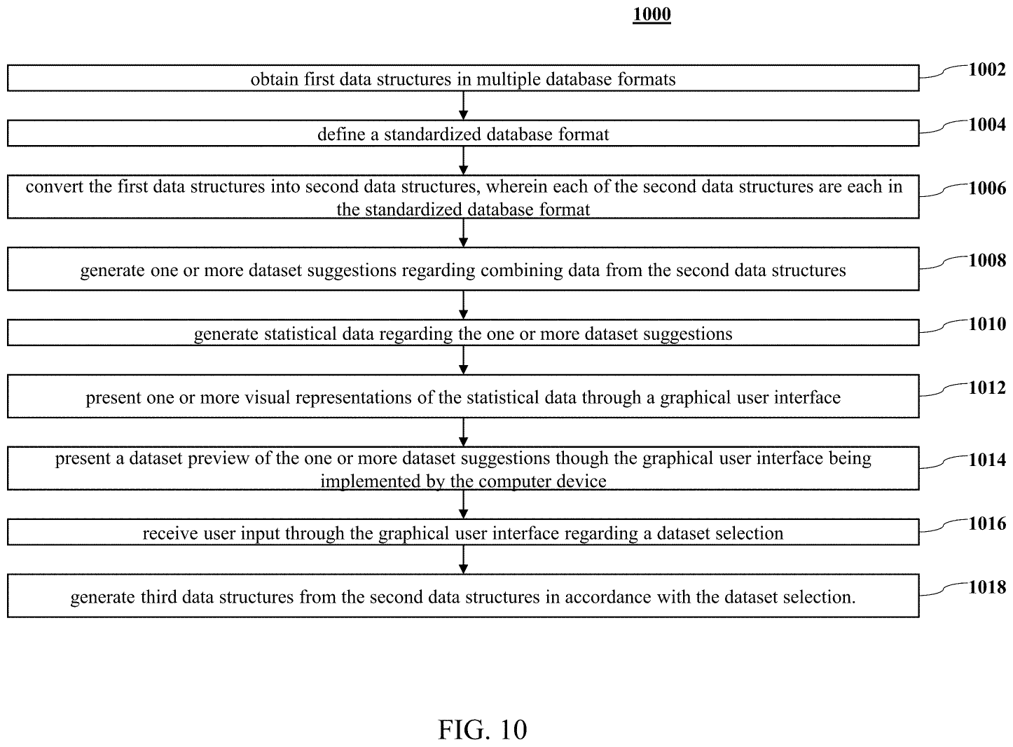

FIG. 10 is a flowchart 1000 regarding a method of standardizing data, in accordance with some embodiments.

Flowchart 1000 includes blocks 1002-1018. The method is implemented by a computer device such as the data standardization device 120 in FIG. 1 and a computer device implementing the data standardization software 900 shown in FIG. 9. Flow begins at block 1002.

At block 1002, first data structures are obtained in multiple database formats. First data structures correspond to data structures 106A(1), 106A(2), 106B(1), 106B(2) in FIG. 1 and data structures 908, 910, 912, 914, 916 in FIG. 9. Flow then proceeds to block 1004.

At block 1004, a standardized database format is defined. An exemplary standardized database format is shown in FIG. 4 as standardized customer database format 400 or database format DBMS as shown in FIG. 9. In some embodiments, the standardized customer database format 400 was defined by the table creation scripts 200, 300 shown in FIG. 2 and FIG. 3. Flow then proceeds to block 1006.

At block 1006, the first data structures are converted into second data structures, wherein each of the second data structures are each in the standardized database format. Exemplary second database structures are shown as database structures 123 in FIG. 1 and database structures 918, 920, 922, 924 in FIG. 9. In some embodiments, the conversion is performed by the data standardization software 122 in FIG. 1 and the data platform 902 shown in FIG. 9. Flow then proceeds to block 1008.

At block 1008, one or more dataset suggestions are generated regarding combining data from the second data structures. Data suggestions are shown as data suggestions named “Sales” in section B of FIG. 5A, data suggestions named “Actual” in section E of FIG. 5B, data suggestions named “Join” in section in section G of FIG. 5C, and the dataset 930 in FIG. 9. Flow then proceeds to block 1010. In some embodiment, the flow proceeds to block 1016 without proceeding to blocks 1010-1014.

At block 1010, statistical data is generated regarding the one or more data suggestions. Examples of the statistical data is visually represented in representation 602, 604 in FIG. 6, representation 702, 704 in FIG. 7. Flow then proceeds to block 1012.

At block 1012, one or more visual representations of the statistical data are presented through a graphical user interface. Examples of the visual representations include representation 602, 604 in FIG. 6, representation 702, 704 in FIG. 7. Examples of the GUI are the GUI 500 shown in FIG. 5A-7. In some embodiments, the statistical data is generated by the dataset engine 932. In some embodiments, the GUI 500 is generated by the visualization engine 934. Flow then proceeds to block 1014.

At block 1014, a dataset preview of the one or more dataset suggestions is presented though the graphical user interface being implemented by the computer device. Examples of the dataset preview include dataset preview 502 in FIG. 5A-5C. In some embodiments, the dataset preview is generated by the dataset engine 932 and is visually presented by the visualization engine 934 through the GUI 500. Flow then proceeds to block 1016.

It should be noted that blocks 1010-1014 are optional. In some embodiments, the user makes selections to perform blocks 1010-1014 and review the results. In other embodiments, one or more of blocks 1010-1014 are not performed.

At block 1016, user input is received through the graphical user interface regarding a dataset selection. Exemplary user inputs are the user input regarding the data selection are discussed received through manipulation of the GUI 500 in FIGS. 5A-5C and the pop-up window 800 in FIG. 8. In some embodiment, the flow proceeds from block 1008 to block 1016 without proceeding to blocks 1010-1014. In that case, the receipt user input can be an input indicating that the user simply agrees or accept the one or more dataset suggestions generated in block 1008. Flow then proceeds to block 1118.

At block 1018, third data structures are generated from the second data structures in accordance with the dataset selection. Exemplary third data structures include the data structures include the data structures 130 shown in FIG. 1 and are generated by the data standardization software 122 of FIG. 1 and the data engine 932 in FIG. 9.

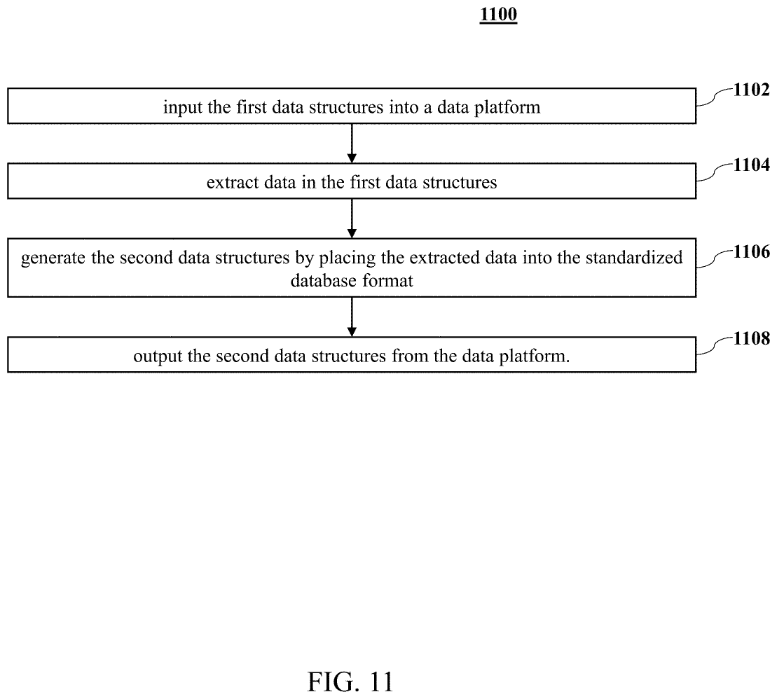

FIG. 11 is a flowchart 1100 regarding a method of converting the first data structures into second data structures in standardized database formats, in accordance with some embodiments.

Flowchart 1100 includes blocks 1102-1108. Flowchart 1100 is an exemplary technique for performing block 1006 in FIG. 10. Flow begins at block 1102

At 1102, the first data structures are input into a data platform. Example of the data platform is the data platform 902 in FIG. 9. Flow then proceeds to block 1104.

At block 1104, data is extracted from the first data structures. Flow then proceeds to block 1106.

At block 1106, the second data structures are generated by placing the extracted data into the standardized database format. Flow then proceeds to block 1108.

At block 1108, the second data structures are outputted from the data platform. In some embodiments, third data structures are formed by combining a first subset of the second data structures with a second subset of the second data structures.

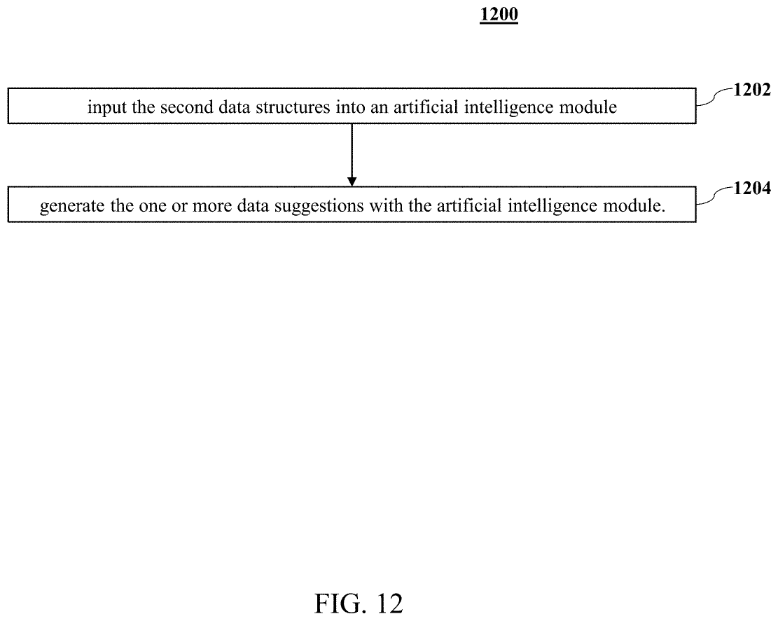

FIG. 12 is a flowchart 1200 regarding a method of generating the one or more data suggestions regarding combining data from the second data structures.

Flowchart 1200 includes block 1202-1204. Flowchart 1200 is one technique for performing block 1008 in FIG. 10, in accordance with some embodiments. Flow begins at block 1202.

At block 1202, the second data structures are input into an artificial intelligence module. An example of the artificial intelligence module is the AI engine 904 in FIG. 9. Flow then proceeds to block 1204.

At block 1204, the one or more data suggestions are generated with the artificial intelligence module.

In some embodiments, a method of standardizing data, includes: obtaining, at a computer device, first data structures in multiple database formats; defining, at the computer device, a standardized database format; and converting, at the computer device, the first data structures into second data structures, wherein each of the second data structures are each in the standardized database format. In some embodiments, converting, at the computer device, the first data structures into second base structures includes: extracting data in the first data structures; and generating the second data structures by placing the extracted data into the standardized database format. In some embodiments, the method further includes: generating, by the computer device, one or more data suggestions regarding combining data from the second data structures; presenting a dataset preview of the one or more data suggestions though a graphical user interface being implemented by the computer device; receiving user input through the graphical user interface regarding a dataset selection; and generating third data structures from the second data structures in accordance with the dataset selection. In some embodiments, generating, by the computer device, the one or more data suggestions regarding combining data from the second data structures includes: inputting the second data structures into an artificial intelligence module implemented by the computer device; and generating the one or more data suggestions with the artificial intelligence module. In some embodiments, the method further includes: generating statistical data regarding the one or more data suggestions; and presenting one or more visual representations of the statistical data through the graphical user interface. In some embodiments, generating the third data structures from the second data structures in accordance with the dataset selection, includes combining a first subset of the second data structures with a second subset of the second data structures. In some embodiments, converting, at the computer device, the first data structures into the second base structures, includes: inputting the first data structures into a data platform; and outputting the second data structures from the data platform.

In some embodiments, a computer system includes: a non-transitory computer readable medium that stores computer executable instructions; at least one processor operably associated with the non-transitory computer readable medium, wherein, when the computer executable instructions are executed by the at least one processor, the at least one processor is configured to: obtain first data structures in multiple database formats; define a standardized database format; and convert the first data structures into second data structures, wherein each of the second data structures are each in the standardized database format. In some embodiments, the at least one processor is configured to convert the first data structures into second data structures by: extracting data in the first data structures; and generating the second data structures by placing the extracted data into the standardized database format. In some embodiments, the at least one processor is further configured to: generate one or more data suggestions regarding combining data from the second data structures; present a dataset preview of the one or more data suggestions though a graphical user interface being implemented by the computer device; receive user input through the graphical user interface regarding a dataset selection; generate third data structures from the second data structures in accordance with the dataset selection. In some embodiments, the at least one processor is configured to generate the one or more data suggestions regarding combining data from the second data structures by: inputting the second data structures into an artificial intelligence module implemented by the computer device; generating the one or more data suggestions with the artificial intelligence module. In some embodiments, the at least one processor is further configured to: generate statistical data regarding the one or more data suggestions; presenting one or more visual representations of the statistical data through the graphical user interface. In some embodiments, the at least one processor is configured to generate the third data structures from the second data structures in accordance with the dataset selection by combining a first subset of the second data structures with a second subset of the second data structures. In some embodiments, the at least one processor is configured to convert the first data structures into the second base structures by: inputting the first data structures into a data platform; outputting the second data structures from the data platform.

In some embodiments, a non-transitory computer readable medium that stores computer executable instructions wherein, when the computer executable instructions are executed by at least one processor, the at least one processor is configured to: obtain first data structures in multiple database formats; define a standardized database format; and convert the first data structures into second data structures, wherein each of the second data structures are each in the standardized database format. In some embodiments, the at least one processor is configured to convert the first data structures into second data structures by: extracting data in the first data structures; and generating the second data structures by placing the extracted data into the standardized database format. In some embodiments, the at least one processor is further configured to: generate one or more data suggestions regarding combining data from the second data structures; present a dataset preview of the one or more data suggestions though a graphical user interface being implemented by the computer device; receive user input through the graphical user interface regarding a dataset selection; generate third data structures from the second data structures in accordance with the dataset selection. In some embodiments, the at least one processor is configured to generate the one or more data suggestions regarding combining data from the second data structures by: inputting the second data structures into an artificial intelligence module implemented by the computer device; generating the one or more data suggestions with the artificial intelligence module. In some embodiments, the at least one processor is further configured to: generate statistical data regarding the one or more data suggestions; presenting one or more visual representations of the statistical data through the graphical user interface. In some embodiments, the at least one processor is configured to generate the third data structures from the second data structures in accordance with the dataset selection by combining a first subset of the second data structures with a second subset of the second data structures.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A method of standardizing data, comprising:
obtaining, at a computer device, first data structures in multiple database formats;
defining, at the computer device, a standardized database format;
converting, at the computer device, the first data structures into standardized, second data structures, wherein each of the second data structures are each in the standardized database format;
extracting, by the computer device, one or more data suggestions of suggested data structures from the standardized, second data structures for generating third data structures from the standardized, second data structures; and
generating, by the computer device, the third data structures from the standardized, second data structures according to at least one of the one or more data suggestions of suggested data structures, wherein the generating the third data structures includes combining a first subset of the standardized, second data structures with a second subset of the standardized, second data structures according to the at least one of the one or more data suggestions of suggested data structures.

2. The method of claim 1, wherein converting, at the computer device, the first data structures into the standardized, second base structures comprises:
extracting data in the first data structures; and
generating the standardized, second data structures by placing the extracted data into the standardized database format.

3. The method of claim 1, further comprising:
presenting a dataset preview of the one or more data suggestions of suggested data structures for combining the first subset of the standardized, second data structures with the second subset of the standardized, second data structures though a graphical user interface being implemented by the computer device;
receiving user input of a selection of the at least one of the one or more data suggestions of suggested data structures through the graphical user interface; and
generating the third data structures from the standardized, second data structures in accordance with the selection of the at least one of the one or more data suggestions of suggested data structures for combining the first subset of the standardized, second data structures with the second subset of the standardized, second data structures.

4. The method of claim 3, wherein generating, by the computer device, the one or more data suggestions of suggested data structures for combining the first subset of the standardized, second data structures with the second subset of the standardized, second data structures comprises:
inputting the standardized, second data structures into an artificial intelligence module implemented by the computer device; and
generating the one or more data suggestions of suggested data structures for combining the first subset of the standardized, second data structures with the second subset of the standardized, second data structures with the artificial intelligence module.

5. The method of claim 3, further comprising:
generating statistical data regarding the one or more data suggestions of suggested data structures for combining the first subset of the standardized, second data structures with the second subset of the standardized, second data structures; and
presenting one or more visual representations of the statistical data through the graphical user interface.

6. (canceled)

7. The method of claim 1, wherein converting, at the computer device, the first data structures into the standardized, second data structures, comprises:
inputting the first data structures into a data platform; and
outputting the standardized, second data structures from the data platform.

8. A computer system, comprising:
a non-transitory computer readable medium that stores computer executable instructions;
at least one processor operably associated with the non-transitory computer readable medium, wherein, when the computer executable instructions are executed by the at least one processor, the at least one processor is configured to:
obtain first data structures in multiple database formats;
define a standardized database format;
convert the first data structures into standardized, second data structures, wherein each of the second data structures are each in the standardized database format;
extract one or more data suggestions of suggested data structures from the standardized, second data structures for generating third data structures from the standardized, second data structures; and
generate the third data structures from the standardized, second data structures according to at least one of the one or more data suggestions of suggested data structures, wherein the generating the third data structures includes combining a first subset of the standardized, second data structures with a second subset of the standardized, second data structures according to the at least one of the one or more data suggestions of suggested data structures.

9. The computer system of claim 8, wherein the at least one processor is configured to convert the first data structures into the standardized, second data structures by:
extracting data in the first data structures; and
generating the standardized, second data structures by placing the extracted data into the standardized database format.

10. The computer system of claim 8, wherein the at least one processor is further configured to:
present a dataset preview of the one or more data suggestions of suggested data structures for combining the first subset of the standardized, second data structures with the second subset of the standardized, second data structures though a graphical user interface;
receive user input of a selection of the at least one of the one or more data suggestions of suggested data structures through the graphical user interface; and
generate the third data structures from the standardized, second data structures in accordance with the selection of the at least one of the one or more data suggestions of suggested data structures for combining the first subset of the standardized, second data structures with the second subset of the standardized, second data structures.

11. The computer system of claim 10, wherein the at least one processor is configured to generate the one or more data suggestions of suggested data structures for combining the first subset of the standardized, second data structures with the second subset of the standardized, second data structures by:
inputting the standardized, second data structures into an artificial intelligence module; and
generating the one or more data suggestions of suggested data structures for combining the first subset of the standardized, second data structures with the second subset of the standardized, second data structures with the artificial intelligence module.

12. The computer system of claim 10, wherein the at least one processor is further configured to:
generate statistical data regarding the one or more data suggestions of suggested data structures for combining the first subset of the standardized, second data structures with the second subset of the standardized, second data structures; and
presenting one or more visual representations of the statistical data through the graphical user interface.

13. (canceled)

14. The computer system of claim 8, wherein the at least one processor is configured to convert the first data structures into the standardized, second data structures by:
inputting the first data structures into a data platform; and
outputting the standardized, second data structures from the data platform.

15. A non-transitory computer readable medium that stores computer executable instructions wherein, when the computer executable instructions are executed by at least one processor, the at least one processor is configured to:
obtain first data structures in multiple database formats;
define a standardized database format;
convert the first data structures into standardized, second data structures, wherein each of the second data structures are each in the standardized database format;
extract one or more data suggestions of suggested data structures from the standardized, second data structures for generating third data structures from the standardized, second data structures; and
generate the third data structures from the standardized, second data structures according to at least one of the one or more data suggestions of suggested data structures, wherein the generating the third data structures includes combining a first subset of the standardized, second data structures with a second subset of the standardized, second data structures according to the at least one of the one or more data suggestions of suggested data structures.

16. The non-transitory computer readable medium of claim 15, the at least one processor is configured to convert the first data structures into the standardized, second data structures by:
extracting data in the first data structures; and
generating the standardized, second data structures by placing the extracted data into the standardized database format.

17. The non-transitory computer readable medium of claim 15, wherein the at least one processor is further configured to:
present a dataset preview of the one or more data suggestions of suggested data structures for combining the first subset of the standardized, second data structures with the second subset of the standardized, second data structures though a graphical user interface;
receive user input of a selection of the at least one of the one or more data suggestions of suggested data structures through the graphical user interface; and
generate the third data structures from the standardized, second data structures in accordance with the selection of the at least one of the one or more data suggestions of suggested data structures for combining the first subset of the standardized, second data structures with the second subset of the standardized, second data structures.

18. The non-transitory computer readable medium of claim 17, wherein the at least one processor is configured to generate the one or more data suggestions of suggested data structures for combining the first subset of the standardized, second data structures with the second subset of the standardized, second data structures by:
inputting the standardized, second data structures into an artificial intelligence module; and
generating the one or more data suggestions of suggested data structures for combining the first subset of the standardized, second data structures with the second subset of the standardized, second data structures with the artificial intelligence module.

19. The non-transitory computer readable medium of claim 17, wherein the at least one processor is further configured to:
generate statistical data regarding the one or more data suggestions of suggested data structures for combining the first subset of the standardized, second data structures with the second subset of the standardized, second data structures; and
presenting one or more visual representations of the statistical data through the graphical user interface.

20. (canceled)
